(19) United States
(12) Patent Application Publication
(10) Pub. No.: US 2026/0096953 A1
(43) Pub. Date: Apr. 9, 2026

(54) MEDICAL FLUID COMPOUNDING SYSTEMS WITH COORDINATED FLOW CONTROL

(71) Applicant: ICU Medical, Inc., San Clemente, CA (US)

(72) Inventor: Philipp Marc Fister, Berlin (DE)

(21) Appl. No.: 19/238,091

(22) Filed: Jun. 13, 2025

Related U.S. Application Data
(63) Continuation of application No. 18/063,537, filed on Dec. 8, 2022, now Pat. No. 12,350,233.
(60) Provisional application No. 63/288,491, filed on Dec. 10, 2021.

(51) Int. Cl. A61J 1/20; A61J 1/22

(52) U.S. Cl. CPC A61J 1/2037; A61J 1/2089; A61J 1/22

(57) ABSTRACT

A system for compounding precise amounts of fluid from one or more source containers into at least one target container is described. The fluid can be drawn from the one or more source containers via an intermediate measuring container such as a syringe pump actuated by a stepper motor or other electronic motor. A system controller can use a measured back EMF value of the motor to determine a pressure within a syringe pump, and control the operation of the motor based at least in part on the determined pressure. The determined pressures of a plurality of syringe pumps can be used to optimize the speed at which the syringe pumps dispense fluid from the source containers while avoiding an overpressure condition which can compromise a compounding process and damage one-way valves within the system.

### RELATED APPLICATIONS

This application is a continuation of U.S. patent application Ser. No. 18/063,537, filed on Dec. 8, 2022, which claims the benefit under 35 U.S.C. § 119(e) of U.S. Provisional Patent Application No. 63/288,491 , filed on Dec. 10, 2021, and entitled, “MEDICAL FLUID COMPOUNDING SYSTEMS WITH COORDINATED FLOW CONTROL,” the entire contents of each of which are hereby incorporated by reference herein and made a part of this specification for all that it discloses.

### BACKGROUND

### Technical Field

Some embodiments in this specification relate generally to devices and methods for transferring fluid and specifically to devices and methods for transferring medical fluids.

### Related Technology

In some circumstances it can be desirable to transfer one or more fluids between containers. In the medical field, it is often desirable to dispense fluids in precise amounts and combinations. Current fluid transfer devices and methods in the medical field suffer from various drawbacks, including potential operational failures or inefficiencies due to the viscosity of at least one of the component fluids of a mixture.

### SUMMARY

In some embodiments, an electronically controlled compounding system can be provided to transfer fluids from a plurality of source containers to a target container. The compounding system can include a plurality of fluid transfer stations, each of the plurality of fluid transfer stations comprising an electric motor and a pump functionally connected to the electric motor. The pump can be actuatable via the electric motor to transfer fluid between a source container and an outlet line in fluid communication with the pump. The compounding system can include a mixing manifold in fluid communication with the outlet lines of each of the plurality of fluid transfer stations, the mixing manifold comprising an outlet connector configured to be placed in fluid communication with a target container. The compounding system can include an electronic controller configured to receive information from each of the plurality of electric motors indicative of a measured back electromotive force (EMF) voltage during operation of the electric motors and control the operation of the plurality of electric motors based at least in part on the received information indicative of the measured back EMF voltages.

### BRIEF DESCRIPTION OF THE DRAWINGS

Certain embodiments of the invention will now be discussed in detail with reference to the following figures. These figures are provided for illustrative purposes only, and the embodiments are not limited to the subject matter illustrated in the figures.

FIG. 1 schematically shows an embodiment of an automated system for transferring precise amounts of fluid.

FIG. 2 schematically shows an embodiment of an automated system for compounding mixtures of precise amounts of fluid.

FIG. 3 is a perspective view of an example of an automated compounding system for transferring fluid having multiple transfer stations.

FIG. 4 schematically illustrates a multiple-source compounder which utilizes multiple syringe pumps to draw fluid from attached source containers and compound the drawn fluid in a target container.

FIG. 5 is a flow diagram illustrating an example embodiment of a method 700 of calculating pressure in a syringe pump based upon a measured back EMF voltage.

FIG. 6 is a flow diagram illustrating an example embodiment of a method 800 of estimating an operating pressure of a compounder comprising a plurality of syringe pumps based upon measured back EMF voltages.

FIG. 7 is a flow diagram illustrating an example embodiment of a method 900 of adjusting dispensing parameters for a compounding process based at least in part on measured back EMF voltages from a plurality of syringe pumps.

### DETAILED DESCRIPTION OF SOME EXAMPLE EMBODIMENTS

The following detailed description is now directed to certain specific example embodiments of the disclosure. In this description, reference is made to the drawings wherein like parts are designated with like numerals throughout the description and the drawings. Nothing in this specification is essential or indispensable; any component, structure, feature, material, method, and/or step can be used separately or omitted. All components, structures, features, materials, methods, and steps that are illustrated and/or described in this specification in separate embodiments can be combined or used separately.

In many circumstances, precise mixtures of fluids are dispensed into a single container in a desired volume, or to provide a desired mixture. For example, a total parenteral nutrition (TPN) solution can be used in an enteral feeding process, and can be provided to a patient via a feeding tube. In order to address the nutritional needs of a particular patient, a precise TPN mixture can be prescribed by a medical practitioner to provide a specific mix of component, such as amino acids, dextrose, and lipids, in a desired ratio and quantity. In some embodiments, a wide range of TPN solutions can be provided by combining a number of source solutions in specific ratios and volumes.

The dispensation and mixture of solutions such as a TPN solution can be at least partially automated through the use of a compounder or other dispensing mechanism which can dispense solutions or other fluids from one or more source containers into one or more target containers. Embodiments of compounders and other dispensing mechanisms can allow for precise, automated dispensation or compounding of a solution such as a TPN solution.

In some circumstances fluid is transferred from a source container to a target container. In some instances, it can be desirable to transfer precise amounts of a fluid such as a medication or solution into the target container. For example, in some embodiments a solution can be stored in a comparatively large container, and a precise dosage amount of the solution can be extracted and transferred to a target device so that a desired dose of the solution can be delivered to a patient. In some embodiments, fluid from multiple source containers can be combined, or compounded, into a single target container. For example, in some embodiments a mixture of solutions can be created in the target container, or a concentrated solution can be combined with a diluent in the target container. To achieve the desired proportions of fluids, it can be desirable to precisely measure the amounts of fluids transferred into the target container. Also, precisely controlling the operation of the fluid transfer process can reduce the amount of fluid wasted (e.g., through improper mixture of the solution in the source container, or backflow into one or more source containers or other components of a compounder or mixing device). Reduction of waste is desirable because in some instances the fluid being transferred can be expensive. Some embodiments disclosed herein provide a fluid transfer device for transferring precise amounts of fluid from one or more source containers into one or more target containers.

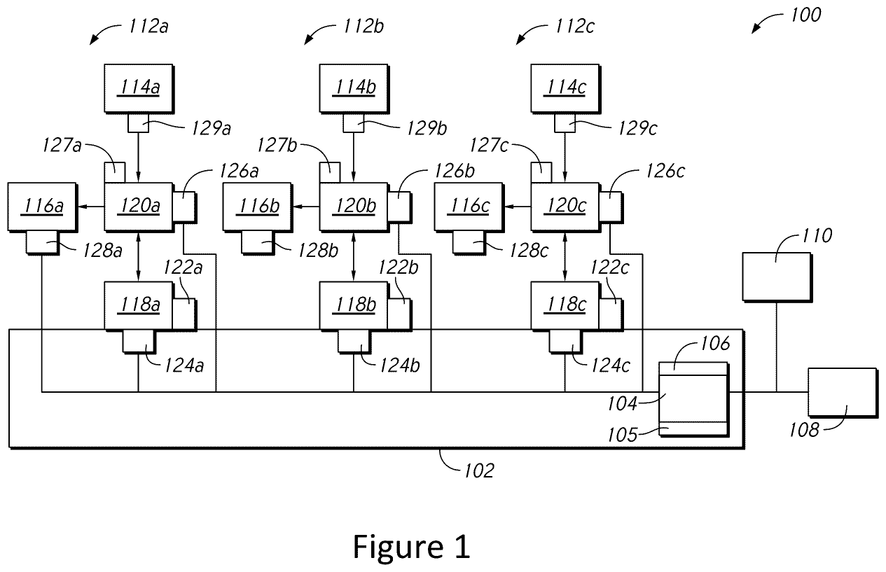

FIG. 1 schematically shows an embodiment of an automated fluid transfer system 100. The system 100 can include a housing 102 enclosing a controller 104 and a memory module 106. The system 100 can also include a user interface 108, which can be, for example, external to the housing 102. The user interface 108 can also be integrated into the housing 102 in some cases. The user interface 108 can include, for example, a display, a keypad, and/or a touch screen display. The user interface 108 can be configured to receive instructions from the user, for example, regarding the amounts of fluid to be transferred and the types of fluids to be transferred. The user interface can also be configured to provide information to the user, such as error messages, alerts, or instructions (e.g., to replace an empty source container). The system 100 can also include a system for obtaining information from a machine-receivable source, such as a bar code scanner 110 or a near-field communication device (e.g., an RFID) in communication with the controller 104. Although in the embodiment shown, the controller 104 and memory module 106 are contained within the housing 102, a variety of other configurations are possible. For example, controller 104 can be external to the housing 102, and can be, for example contained within a second housing which also contains the user interface 108. In some embodiments, the system 100 can include a communication interface 105 configured to receive information (e.g., instructions) from a remote source such as a terminal or an automated management system, etc. In some embodiments, the communication interface can also send information (e.g., results or alerts) to the remote source. In some embodiments, the system 100 does not include a communication interface 105 and does not communicate with a remote source.

The system 100 can include multiple transfer stations 112a-c. In the embodiment shown, the system 100 includes three transfer stations 112a-c, but a different number of transfer stations can be used. For example, in some embodiments, the system can include a single transfer station. In other embodiments, the system can include two, four, five, six, seven, eight, or more transfer stations depending on the number of different fluid types the system is designed to handle and the amount of fluid to be transferred.

Each transfer station 112a-c can include a fluid source container 114a-c, which can be, for example, a medical vial or other suitable container such as a bag, a bottle, or a vat, etc. Although many embodiments disclosed herein discuss using a particular type of source container as the source container, it will be understood the other containers can be used even when not specifically mentioned. In some embodiments, each of the source containers 114a-c can contain a unique fluid, providing a variety of fluids that the user can select for transfer. In other embodiments, two or more of the source containers 114a-c can contain the same fluid. In some embodiments, the source containers 114a-c include machine-receivable sources, such as bar codes, that identify the types of fluid contained therein. The bar codes can be scanned by the scanner 110 so that the identities of the fluids contained by source containers 114a-c can be stored within memory module 106. In some embodiments, the fluid transfer stations 112a-c are configured to transfer precise amounts of fluid from source containers 114a-c to target containers 116a-c, which can be, for example IV bags. It will be understood that in various embodiments described herein, a different type of target connector or destination container can be used instead of an IV bag (e.g., a syringe, a bottle, a vial, etc.) even when not specifically mentioned.

In some embodiments the fluid can first be transferred from source containers 114a-c to intermediate measuring containers 118a-c so that a precise amount of fluid can be measured. The intermediate measuring containers 118a-c can be, for example, syringes. After being measured, the fluid can be transferred from intermediate measuring containers 118a-c to the target containers 116a-c. In some embodiments, one or more of the transfer stations 112a-c can include one or more pairs of male and female fluid connectors configured to be attached to each other to selectively permit the passage of fluid. When fluid transfer is completed, the connectors can be detached or disconnected. In some embodiments, the connectors can be configured to automatically close. The fluid module can be removed while retaining substantially entirely or entirely all of the remaining interior fluid within the respective connectors and the rest of the fluid module, thus permitting the transfer to occur in a substantially entirely or entirely closed system, thereby diminishing the risk of damage caused by liquid or vapor leakage from the fluid module after disconnection and from the fluid source and the fluid destination after disconnection.

In some embodiments, the system 100 can be configured to be compatible with a variety of sizes of syringes. For example, larger volume syringes can be used to transfer larger volumes of fluid in shorter amounts of time. Smaller volume syringes can be used to increase the accuracy and precision with which amounts of fluid can be transferred. In some embodiments, the syringes can include a machine-receivable source, such as a bar code, which identifies the volume of the syringe. The bar code can be scanned by a bar code scanner 110, so that the sizes of the syringes used by the different transfer stations 112a-c can be stored within memory module 106 for use by the controller 104.

In some embodiments, connectors 120a-c connect the source containers 114a-c, the intermediate containers 118a-c, and the target containers 116a-c. In some embodiments, the connectors 120a-c can include first check valves (not shown) configured to allow fluid to flow from the source containers 114a-c into the connector 120a-c, and block fluid from flowing connector 120a-c into the source containers 114a-c, as shown by single-headed arrows. The connectors 120a-c can also include second check valves (not shown) configured to allow fluid to flow from connectors 120a-c into target containers 116a-c, but block fluid from flowing from target containers 116a-c into connectors 120a-c, as shown by single-headed arrows. In some embodiments, the connectors 120a-c can be in two-way fluid communication with the intermediate containers 118a-c, as shown by double-headed arrows.

In some embodiments, the system 100 can include mounting modules 122a-c for mounting the transfer stations 112a-c onto the housing 102. For example, in some embodiments the mounting modules 122a-c can be configured to securely receive intermediate measuring containers 118a-c as shown in FIG. 1. The system 100 can also include motors 124a-c, which can be for example, contained within housing 102. The motors 104a-c can be configured to actuate the plungers on the syringes 118a-c to draw fluid into the syringes and to dispel fluid therefrom. The motors 124a-c can be in communication with the controller 104, and can receive actuation instructions from the controller 104. The motors 124a-c can also provide signals to the controller 104 indicative of the current operational state of the motors 124a-c, as discussed in greater detail below.

In some embodiments, the system can include fluid detectors 126a-c configured to detect a presence or absence of fluid in connectors 120a-c. The fluid detectors 126a-c can be in communication with the controller 104 so that when the detectors 126a-c detect an absence of fluid in connectors 120a-c, indicating that source fluid containers 114a-c have run dry, they can send a signal to controller 104 that a source container 114a-c needs to be replaced. The fluid detectors 126a-c can be for example an infrared LED and photo detector, or other type of electronic eye, as will be discussed in more detail below. In the embodiment shown, fluid detectors 126a-c are shown connected to connectors 128a-c, but other configurations are possible. For example, fluid detectors 126a-c can be connected to fluid source containers 114a-c themselves.

In some embodiments, the system 100 can include compatibility mechanisms 127a-c for ensuring that an approved connector 120a-c has been placed in communication with the system 100 to ensure the accuracy of the amount of fluid transferred. The compatibility mechanisms 127a-c can be, for example, a specifically shaped mounting feature configured to correspond to a portion of the connector 120a-c.

In some embodiments, the system 100 can include source adapters 129a-c configured to receive the source containers 114a-c and removably connect to the connectors 120a-c. Thus, when a source container 114a-c runs out of fluid, the empty source container 114a-c and its corresponding adapter 129a-c can be removed and replaced without removing the associated connector 120a-c from the system 100. In some embodiments, source adapters 129a-c can be omitted, and the source containers 114a-c can be directly received by the connectors 120a-c.

In some embodiments the system 100 can include sensors 128a-c for detecting the presence of target containers 116a-c. Sensors 128a-c can be in communication with the controller 104 so as to prevent the system 100 from attempting to transfer fluid when no target container 116a-c is connected. A variety of sensor types can be used for sensors 128a-128c. For example, sensors 128a-c can be weight sensors or infrared sensors or other form of electronic eye. In some embodiments, weight sensors 128a-c can also be used to measure the weight of the target containers 116a-c after fluid has been transferred. The final weight of a target container 116a-c can be compared to an expected weight by the controller 104 to confirm that the proper amount of fluid was transferred into the target container 116a-c. Sensors 128a-c can be a variety of other sensor types, for example sensor pads or other sensor types able to detect the presence of target containers 116a-c.

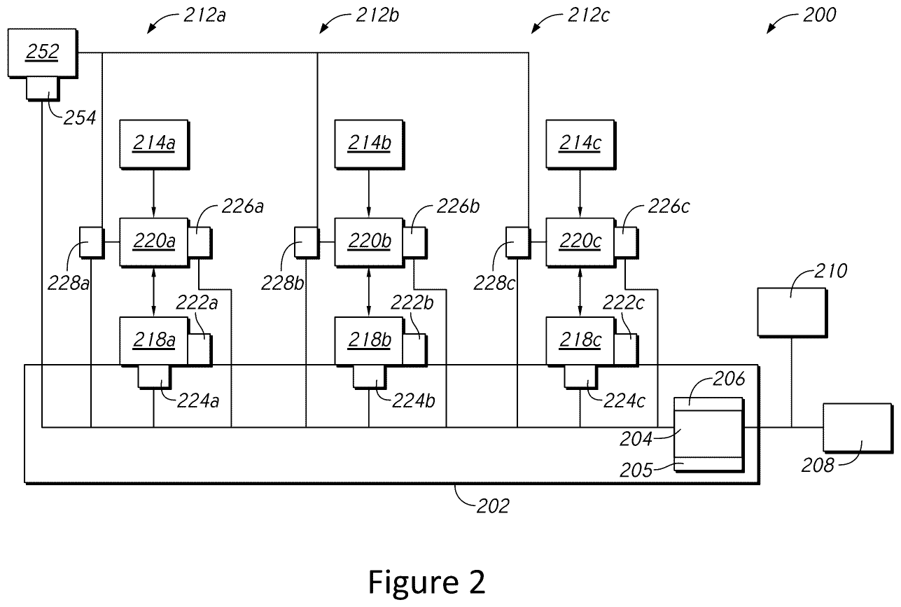

FIG. 2 schematically illustrates a system 200 for automated precise transfer of fluids. System 200 can be the same as or similar to the system 100 in some regards. Some features shown in FIG. 1, such as the adapters 129a-c and compatibility mechanisms 127a-c, are not shown specifically in the system 200, but it will be understood that system 200 can include corresponding features. The system 200 can include a housing 202, a controller 204, a memory 206, a user interface 208, a scanner 210, and a communication interface 205, similar to those describe above in connection with the system 100. System 100 is configured to transfer individual fluids from the source containers 114a-c to target containers 116a-c. System 200, on the other hand, is configured to transfer and combine fluids from source containers 214a-c into a common target container. Thus, system 200 can be used for compounding mixtures of fluids. In some embodiments, a single system can be configured both for compounding mixtures of fluids and for the transfer of individual fluids from a single-source container to a single-target container. For example, a system containing six fluid transfer stations can be configured so that transfer stations 1-3 are dedicated to compounding mixtures of fluids into a single common target container, while fluid transfer stations 4-6 can be configured to each transfer fluid from a single source container to a single target container. Other configurations are possible. In the embodiment shown in FIG. 2, the system 200 can include sensors 228a-c for detecting whether or not the connectors 220a-c are connected to the common target container 216. The system 200 can also include a sensor for detecting the presence of the common target container 216. In some embodiments, the sensor can measure the weight of the common target container 216 and can report the weight to the controller 104. The controller 104 is then able to compare the final weight of the common target container with an expected weight to confirm that the common target container was filled with the correct amount of fluids.

In some embodiments, a system 200 can be a TPN compounder, such as a total parenteral nutrition (TPN) compounder for providing a customized TPN solution from a plurality of source solutions.

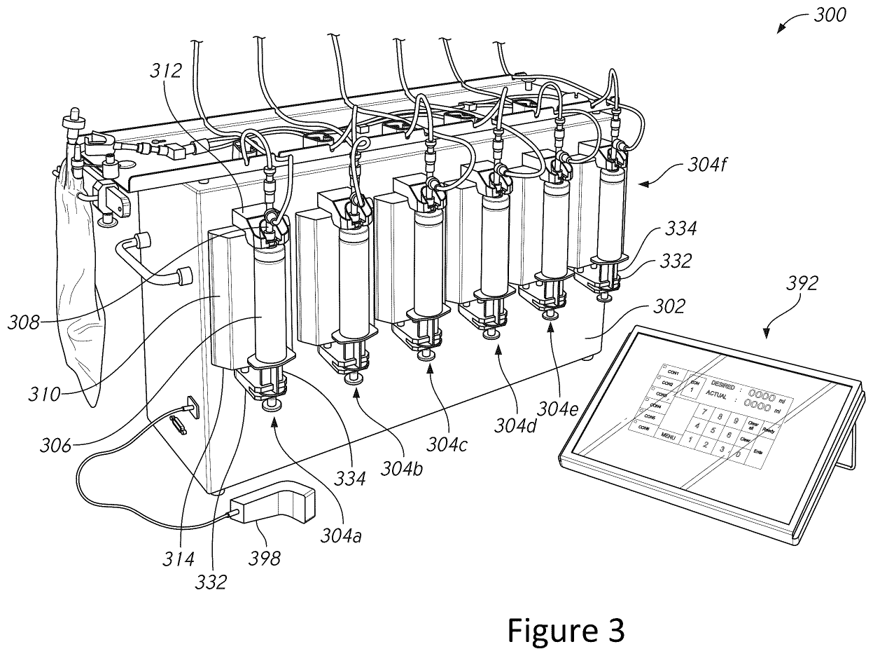

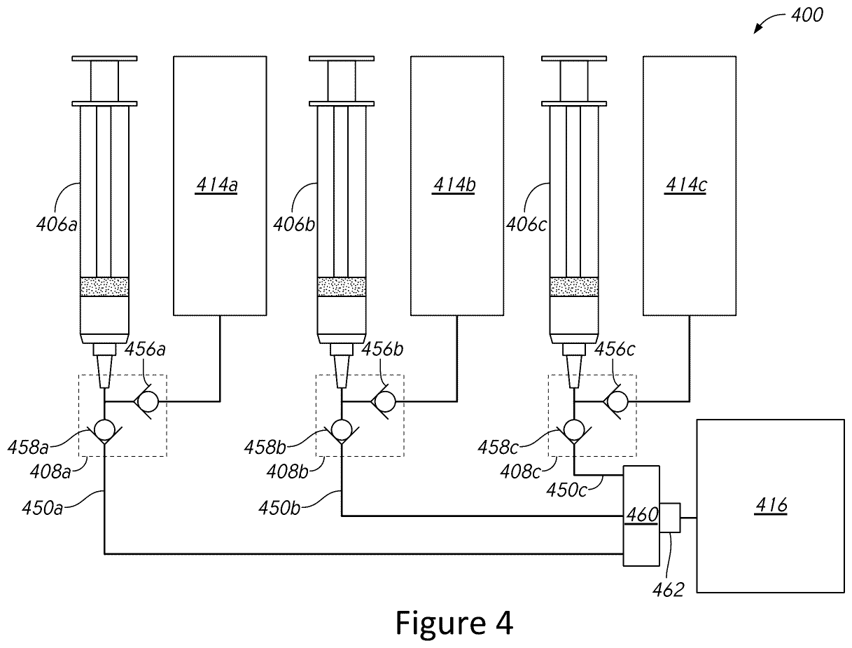

FIG. 3 is a perspective view of an automated system 300 for transferring fluid. Any component, structure, material, method, and/or step that is illustrated and/or described in connection with FIG. 3 can be used with or instead of any component, structure, material, method, and/or step that is illustrated and/or described in any other embodiment in this specification or known in the art. The automatic system 300 can be similar to or the same as the other automated fluid transfer systems (e.g., 100, 200) disclosed herein. The system 300 can include a base housing 302, and six transfer stations 304a-f, located on a front side of the base housing 302. In some embodiments, the system 300 can include a different number of transfer stations 304a-f (e.g., one, two, four, five, eight, or more transfer stations). In some embodiments, the transfer stations 304a-f can be distributed on multiple sides of the base housing 302. Transfer stations 304b-f are shown in an empty state having no syringe attached thereto. Transfer station 304a is shown having a syringe 306 and a connector 308 attached thereto. During operation, a source container (see FIG. 4) can be attached to the top of the connector 308 and an IV bag (not shown) can be placed in fluid connection with the connector 308 so that fluid can be transferred from the fluid source container to the syringe 306 and then from the syringe 306 into the IV bag, as discussed in greater detail elsewhere herein. Also, during operation, some or all of the transfer stations 304a-f can be equipped similarly to transfer station 304a. In some embodiments, multiple transfer stations 304a-f can operate simultaneously. In some embodiments, multiple transfer stations 304a-f can be placed in fluid communication with a single IV bag so that fluid from multiple fluid source containers can be combined into a single IV bag. In some embodiments, one or more of the transfer stations 304a-f can include a dedicated IV bag so that fluid from only a single transfer stations can be transferred into the dedicated IV bag.

The transfer station 304a can include an auxiliary housing 310 connected to the base housing 302. The transfer station 304a can also include a top connector piece 312 attached to the base housing 302 above the auxiliary housing 310, and a bottom connector piece 314 attached to the base housing 302 below the auxiliary housing 310. The top connector piece 312 and the bottom connector piece 314 can extend out a distance past the auxiliary housing 310, and a pair of guiding shafts (not shown) can extend vertically between the top connector piece 312 within the auxiliary housing 310 and the bottom connector piece 314. A middle connector piece (not shown) can be attached to the shafts. The transfer station 304a can include an actuator 332 configured to retract and advance the plunger 334 of the syringe 306. In the embodiment shown, the actuator 332 includes an actuator base 336.

In some embodiments, a motor (not shown) is located inside the auxiliary housing 310. The motor can be an electric motor, a pneumatic motor, a hydraulic motor, or other suitable type of motor capable of moving the actuator 332. In some embodiments, the motor can be a piston type motor. In some embodiments, the motor is contained within the base housing 302 rather than in the auxiliary housing 310. In some embodiments, each transfer station 304a-f has an individual motor dedicated to the individual transfer station 304a-f. In some embodiments, one or more of the transfer stations 304a-f share a motor, and in some embodiments, the system 300 includes a single motor used to drive all the transfer stations 304a-f. The motor can drive the shafts 338a-b downward out of the auxiliary housing 310, which in turn drives the rest of the actuator 332 downward causing the plunger 334 to retract from the syringe body 324 to draw fluid into the syringe. The motor can drive the rest of the actuator 332 upward, causing the plunger 334 to advance into the syringe 306 to expel fluid from the syringe.

The system 300 can include a controller, for controlling the operations of the transfer stations 304a-f. The controller can start and stop the motor(s) of the system 300 to control the amount of fluid that is transferred from the fluid source container to the IV bag at each transfer station 304a-f. The controller can be one or more microprocessors or other suitable type of controller. The controller can be a general purpose computer processor or a special purpose processor specially designed to control the functions of the system 300. The controller can include, or be in communication with, a memory module that includes a software algorithm for controlling the operations of the system 300. The controller can be contained within the base housing 302. In some embodiments, the controller can be external to the base housing 302, and can be for example the processor of a general purpose computer that is in wired or wireless communication with components of the system 300.

In some embodiments, any transfer station 304a can include a sensor configured to determine when the liquid in the source container has run out. If the plunger 334 is retracted to draw fluid into the syringe 306 when the fluid source container contains no more fluid, air is drawn out of the fluid source container and travels into the connector 308 toward the syringe. Air can also be drawn into the connector 308 when the fluid source container still contains a small amount of fluid, but the fluid level is low enough that air is drawn out of the fluid source container along with the fluid (e.g., as an air bubble). In some embodiments, the sensor can detect air in the connector 308. For example, the sensor can be an infrared light source (e.g., an LED) and a photodetector, or other form of electric eye.

As shown in FIG. 3, the system 300 can include a user interface 392 for receiving information and commands from the user and for providing information to the user. The user interface 392 can be part of an external unit, or it can be integrated into or attached to the base housing 302. The user interface 392 can include, for example, a touch screen display. The user interface 392 can be in wired or wireless communication with the controller. In some embodiments, a cable connects the external unit to the base housing 302 and provides a communication link between the user interface 392 and the controller. In some embodiments, the controller can be contained in the external unit along with the user interface 392 and the controller can send and receive signals to and from components (e.g., the motors) of the system 300 through the cable. The user interface 392 can be configured to receive instructions from the user regarding the amounts of fluids to be transferred by the transfer stations 304a-304f. The user interface 392 can deliver the instructions to the controller to be stored in a memory and/or used to actuate the motor(s) to transfer the desired amount of fluids.

In some embodiments, the system 300 can include a communication interface. The communication interface can be configured to provide a communication link between the controller and a remote source, such as a remote terminal or an automated management system. The communication link can be provided by a wireless signal or a cable or combination of the two. The communication link can make use of a network such as a WAN, LAN, or the internet. In some embodiments, the communication interface can be configured to receive input (e.g., fluid transfer commands) from the remote source and can provide information (e.g., results or alerts) from the controller to the remote source. In some embodiments, the remote source can be an automated management system which can coordinate actions between multiple automated fluid transfer systems (e.g., 100, 200, and 300).

The system 300 can also include a device for receiving information from a machine-receivable source, such as a bar code scanner 398 or other device, in communication with the controller and/or memory. The bar code scanner 398 can be used to provide information about the system 300 to the controller and/or the memory. For example, the syringe 306 can include a bar code that identifies the size and type of the syringe 306. The user can scan the syringe 306 with the bar code scanner 398 and then scan a bar code associated with the transfer station 304a to inform the controller of the size of the syringe 306 that is attached to the transfer station 304a. Different sizes of syringes can hold different volumes of fluid when their plungers are withdrawn by the same distance. Thus, when the controller is tasked with filling the syringe 306 with a predetermined amount of fluid, the controller can determine how far the plunger is to be withdrawn to fill the particular type of syringe with the predetermined amount of fluid. The fluid source containers (not shown) can also include bar codes that indicate the type of fluid contained therein. The user can scan a fluid source container and then scan the bar code associated with the particular transfer station the fluid source container is to be installed onto. Thus, the controller can be aware of what fluids are controlled by which transfer stations to facilitate automated transfer of fluids. Other components of the system 300 can also include bar codes readable by the bar code scanner 398 for providing information about the components to the controller and/or memory. In some embodiments, the user interface 392 can be configured to allow the user to input data relating to the size of the syringe 306, the type of fluid contained in a fluid bag, etc. instead of using the bar code scanner 398.

FIG. 4 schematically illustrates a multiple-source compounder which utilizes multiple syringe pumps to draw fluid from attached source containers and compound the drawn fluid in a target container. The compounder 400 includes a plurality of source containers 414a, 414b, and 414c, each of which can contain a fluid such as a component solution of a TPN solution. In the illustrated embodiment, three source containers are shown, although in other embodiments, any suitable number of source containers can be used. Each of the source containers 414a, 414b, and 414c is in fluid communication, via a respective connector 408a, 408b, or 408c, with a respective intermediate measuring container such as one of syringe pumps 406a, 406b, or 406c. Any description or illustration of a syringe pump in this specification can alternatively be substituted or replaced with any other suitable type of medical pump, including but not limited to a peristaltic pump, an elastomeric pump, and/or a bladder pump.

In the illustrated embodiment, the connectors 408a, 408b, and 408c are two-way check valve connectors. In other embodiments, however, the intermediate measuring containers can include distinct inlet and outlet connectors, or any other suitable connectors.

In the illustrated embodiment, the intermediate measuring containers are syringe pumps 406a, 406b, and 406c, which can include a syringe which can be controlled by a linear actuation mechanism which engages a portion of the syringe to control the translation of the plunger within the syringe. The syringe pumps 406a, 406b, and 406c can be releasably coupled to a linear actuation mechanism via a driving component such as the actuator 332 of the transfer station 308a of FIG. 3.

In some embodiments, the driving component can be linearly translated through the use of a stepper motor which drives a ball screw nut to move the driving component, but a wide variety of other suitable mechanical linkages can be used in other embodiments. The driving component, or another connecting portion moveable along with the driving component, can engage a portion of the perfusion syringe to cause the plunger to be moved relative to the remainder of the perfusion syringe, increasing or decreasing the volume of the interior chamber defined by the syringe to operate one of the syringe pumps 406a, 406b, or 406c.

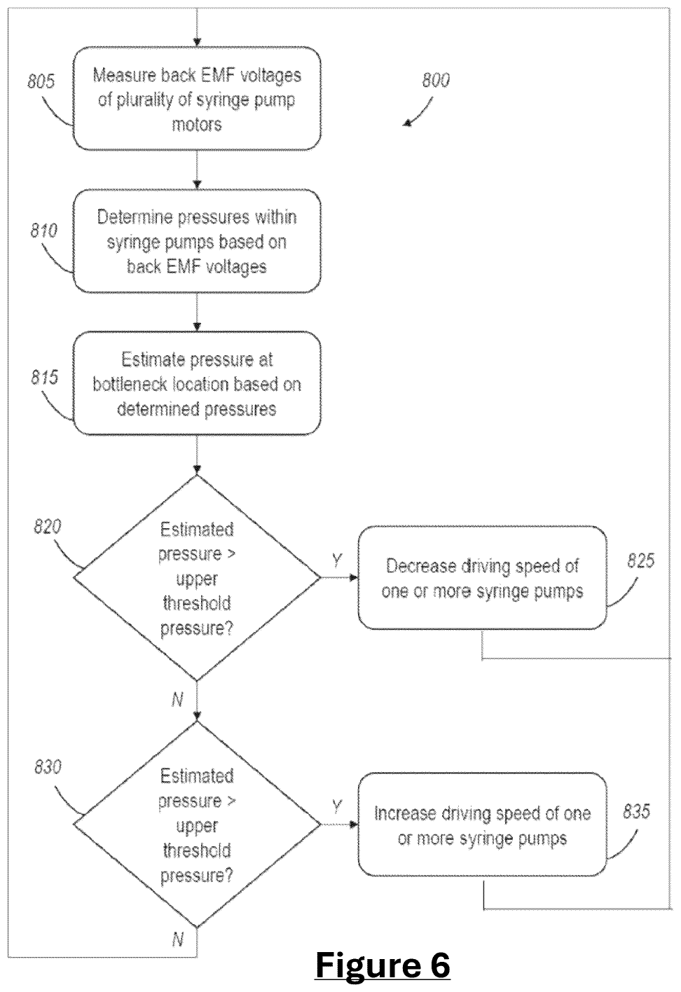

Fluid can be drawn from the source container 414a into the body of the syringe pump 406a by controlling the actuator mechanism of the syringe pump 406a to withdraw the plunger of the syringe pump 406a. A source check valve 456a is disposed within the connector 408a along the fluid path between the source container 414a and the syringe pump 406a. The source check valve 456a can include any suitable check valve, such as a duckbill check valve as illustrated in FIG. 6A, although in other embodiments, any other suitable check valve or one-way valve can be used. The source check valve 456a of the connector is oriented to permit fluid to be drawn from the source container 414a into the body of the syringe pump 406a when the syringe plunger is withdrawn, but prevent backflow from the syringe pump 406a into the source container 414a when the syringe plunger is depressed.

Once a desired amount of fluid has been drawn into the interior of the syringe pump 406a, the syringe plunger may be depressed by linearly translating the driving component in the opposite direction to reduce the volume of the interior of the syringe pump 406a, forcing fluid out of the syringe pump 406a. The fluid is prevented from backflowing into the source container 414a by the orientation of source check valve 456a, but permitted to flow through the target check valve 458a due to the opposite orientation of the target check valve 458a. After passing through the target check valve 458a, the fluid flows through outlet line 450a towards a mixing manifold 460 in fluid communication with each of outlet lines 450a, 450b, and 450c.

The mixing manifold 460 may be removably placed, via manifold connector 462, in fluid communication with a target container 416 via a luer connection or any other suitable mechanical connection which allows the target container 416, or a length of tubing extending therefrom, to be releasably connected to the manifold connector 462. A luer connection such as the manifold connector 462, downstream of the manifold 460, can have a smaller bore than the surrounding tubing, and may function as an overall bottleneck to the compounder system 400.

A wide variety of connector designs can be used to control the fluid exchange between the source containers, the syringe pumps, and the outlet lines. For example, the connector system can include one or more one-way valves placed in appropriate locations in fluid communication respectively with a source container, a syringe pump, and an outlet line. Flow of fluid and air throughout the connector can be constrained through a plurality of check valves disposed throughout the connector.

As shown in FIG. 4, a plurality of output lines such as outlet lines 450a, 450b, and 450c flow into the manifold 460. A flow constraining component downstream of the manifold 460, such as a luer manifold connection 462 or another component downstream of mixing manifold 460 of the compounder 400, may serve as a bottleneck for the compounder. If the flow rate of the compounded solution is constrained by the manifold connector 462 or another downstream component, the pressure within the system may increase, putting increased pressure on the target check valves 458a, 458b, and 458c. If the pressure exceeds a failure threshold of the target check valves 458a, 458b, and 458c, one or more of the target check valves 458a, 458b, and 458c may fail, allowing backflow from the adjacent output line back through the target check valve and towards the connected syringe pump.

For example, if operational pressure in one of the syringe pumps 406a, 406b, or 406c is sufficiently high, the downstream line pressure at or beyond the manifold connector 462 may cause failure of one or more of the target check valves 458a, 458b, and 458c connected to another syringe pump. Such a pressure increase may occur, for example, when the fluid being dispensed has a viscosity sufficiently high that the fluid cannot be freely dispensed at the rate at which the syringe plunger of the syringe pump is being depressed. In particular, components of a TPN solution, such as a lipid emulsion solution, may have a comparatively high viscosity in comparison to other pharmaceutical fluids.

This backflow can affect the current compounding process, causing less solution to be dispensed than intended, as some fluid can flow back into a syringe pump intended to be in an empty state. This backflow can also affect subsequent compounding processes, causing the backflowed solution to be dispensed in addition to the desired dispensed amount. Even if these errors are caught by other means, such as by measuring the weight of the dispensed fluid in the source container, this can result in wasted time and material if an additional compounding process is required to provide a replacement solution.

Such pressure spikes, and the corresponding backflow, can be minimized or prevented by constraining the rate at which fluid is dispensed from the syringe pumps. However, an overly cautious approach may result in unnecessarily limiting the overall speed of the compounding processes. Given sufficient experience, an operator can manually optimize the various dispensing channels for the particular fluids and solutions being dispensed therefrom. Such optimization is the result, however, of experience and trial and error. Incorporation of sensors into the perfusion syringes or other disposable components of the compounder to detect an overpressure condition or the resulting pressure-induced backflow or valve failure may increase the cost and complexity of the system.

In some embodiments, the operating conditions of a stepper motor driving a syringe pump may be monitored during operation of the syringe pump in order to obtain a measurement of the torque of the motor without the need for the inclusion of additional sensors.

Electric motors such as a stepper motor operate by generating rotating electromagnetic fields using stator coils. This allows precise control over the position and speed of the stepper motor. During operation of a stepper motor through the generation of a driving electromotive force (EMF), the rotation of the rotor relative to the stator coils generates a back EMF opposing the driving EMF. The back EMF is proportional to the angular velocity of the motor, and is affected by the load on the motor. When the motor is unloaded, the back EMF will be almost equal to the driving EMF, as the motor only needs to work to overcome friction. When driven with a sinusoidal signal, the load angle in an unloaded state will be almost zero. As the load increases, the back EMF will drop, and the load angle will shift as the power is required to overcome the load.

For a stepper motor with known or measured mechanical properties, such as a given torque constant, the measured back EMF voltage can be used in conjunction with the driving voltage to calculate the torque output of the motor. The measured torque being applied to a linear actuator, such as a ball screw nut, can be used to calculate the linear force applied by the linear actuator as a function of the application of the measured torque. In turn, the applied force can be used to calculate the pressure within a syringe pump based upon the dimensions of the syringe pump.

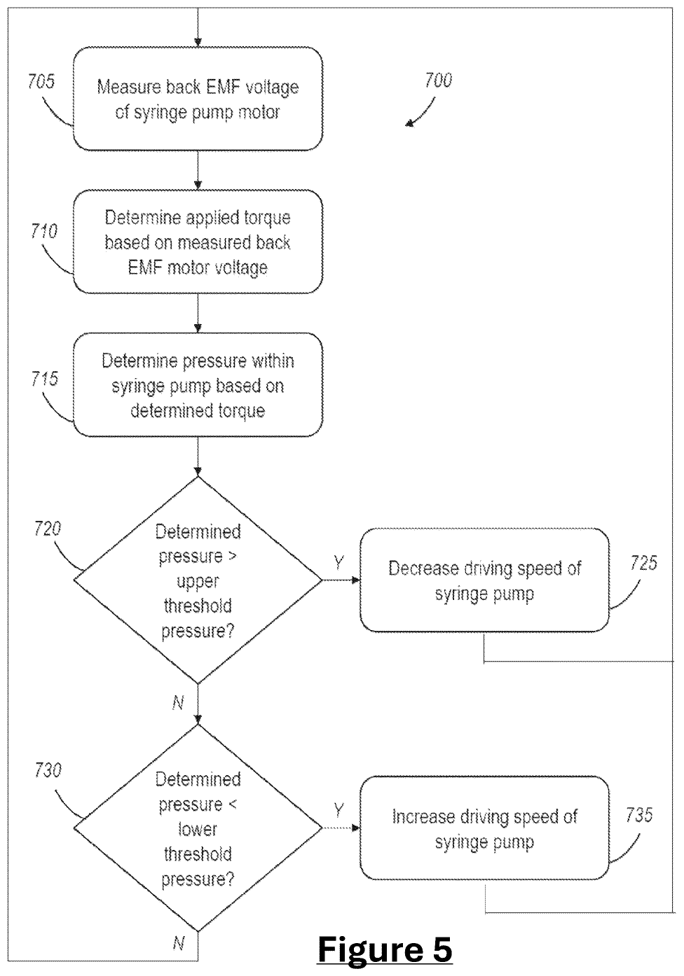

FIG. 5 is a flow diagram illustrating an example embodiment of a method 700 of calculating pressure in a syringe pump based upon a measured back EMF voltage. At block 705, the back EMF voltage of an electric motor of a syringe pump is measured. In some embodiments, control circuitry of the electric motor can be used to output a signal indicative of the measured back EMF voltage. In some embodiments, such a back EMF voltage signal may be received over a wired or wireless connection by a controller of the syringe pump.

At block 710, the measured back EMF voltage or a received signal indicative of the measured back EMF voltage is used to determine the torque applied by the electric motor. In some embodiments, this calculation may be performed within the control circuitry of the electric motor, and the control circuity may output a signal indicative of the torque of the electric motor. In some embodiments, such a torque signal may be received over a wired or wireless connection by a controller of the syringe pump. In other embodiments, the controller may calculate the torque applied by the electric motor based on a received back EMF voltage signal. This calculation may be performed based on mechanical parameters of the motor, which may be inputted or programmed manually, provided in a lookup table, or may be determined through a calibration process, such as by driving the electric motor against a mechanical stop.

At block 715, the determined torque is used to determine the pressure within the syringe pump based upon the parameters of the syringe pump, such as the mechanical properties of the linear actuator and the cross-sectional size of the syringe. In some embodiments, the force applied by the linear actuator on the syringe plunger may be determined, e.g., based upon the dimensions of the ball screw nut or other cam structure of the linear actuator. The applied force may then be used to calculate the pressure within the syringe pump based upon the cross-sectional dimensions of the syringe.

As described with respect to FIG. 3, a bar code or other identifying information may be provided on a syringe to identify the syringe, and to provide information regarding the properties of the syringe. With the dimensions of the syringe known, such as the cross-sectional dimensions of the syringe interior, the linear displacement of the syringe plunger may be correlated to the corresponding volumetric change in the internal dimensions of the syringe. This allows the determination of the linear displacement of the plunger required to fill the syringe pump with a desired volume of fluid, and to dispense the same.

In some embodiments, the signal indicative of the back EMF may be used to directly determine the pressure within the syringe pump, and discrete intermediate steps of determination of torque being applied by the motor and/or the force being applied on the syringe plunger can be omitted. This determination of the pressure within the syringe may be performed periodically throughout the operation of the syringe. In particular, the pressure may be monitored when the syringe plunger is being depressed to expel fluid contained within the syringe through the target check valve and into the outlet line towards the mixing manifold.

At block 720, the determined pressure can be compared to at least one threshold pressure. In some embodiments, the comparison may be only to an upper pressure threshold. If the determined pressure within the syringe exceeds the upper pressure threshold, the process may move to a block 725, where the driving speed of the syringe pump may be lowered, as discussed in greater detail below. If the determined pressure remains below the upper threshold pressure, the driving speed of the syringe pump may be left at its current speed, and the process may optionally return to block 705 and periodically repeat the process 700 during operation of the syringe pump.

In some embodiments, the process may move to a block 730, where the determined pressure may optionally be compared to a lower pressure threshold. In some embodiments, the lower pressure threshold may be less than the upper pressure threshold, while in other embodiments, the lower pressure threshold may be equal to the upper pressure threshold. If the determined pressure remains above the lower threshold pressure, in addition to remaining below the upper threshold pressure, the driving speed of the syringe pump may be left at its current speed, and the process may optionally return to block 705 and periodically repeat the process 700 during operation of the syringe pump. If the determined pressure is below the lower threshold pressure, a determination can be made that the syringe pump could operate at a higher driving speed without generation of a pressure spike which would impact the operation of the compounder. The process may optionally move to a block 735, where the driving speed of the syringe pump may be increased, as discussed in greater detail below.

If the process moves to block 720 or 730, an appropriate adjustment to the driving speed of the syringe plunger may be made. In some embodiments, the driving speed may be adjusted by a predetermined increment or percentage, or adjusted between one of a number of predetermined speeds. In some embodiments, the speed adjustment may be based at least in part on the magnitude of the difference between the determined pressure and the threshold pressure, with larger adjustments being made when the determined pressure is significantly different beyond the threshold pressure to which it is compared. As discussed in greater detail below, the speed adjustments may also be based at least in part on the operational state and determined pressure of other syringe pumps. In some embodiments, sufficiently large pressure differentials may trigger an error state due to possible clogs or blockage within the compounder system.

As described above, an experienced operator may, through trial and error, develop knowledge of suitable operating speeds for various source solutions, allowing the hand optimization of the operating speed of the various syringe pumps. However, if the viscosity of a given source solution is unknown, or is different than anticipated for any reason, an operator may in some instances default to a slower operating speed than necessary, as a precautionary measure which reduces the overall throughput of the compounder. Alternately, the operator may set the operating speed too high, and cause compounding errors due to pressure spikes which result in overall waste and delay.

In some embodiments, the pressure at another location in the compounding system may be estimated based on the determined pressure within one or more syringe pumps. For example, an average of the determined pressures within the operating syringe pumps may be used as an estimate of the pressure at a downstream location such as a manifold connector.

FIG. 6 is a flow diagram illustrating an example embodiment of a method 800 of estimating an operating pressure of a compounder comprising a plurality of syringe pumps based upon measured back EMF voltages. At block 805, the back EMF voltages of the electric motors of a plurality of syringe pumps are measured. These back EMF voltages can be measured substantially simultaneously, although in other embodiments periodic staggered measurements may also be made, depending on the length of the sampling cycle.

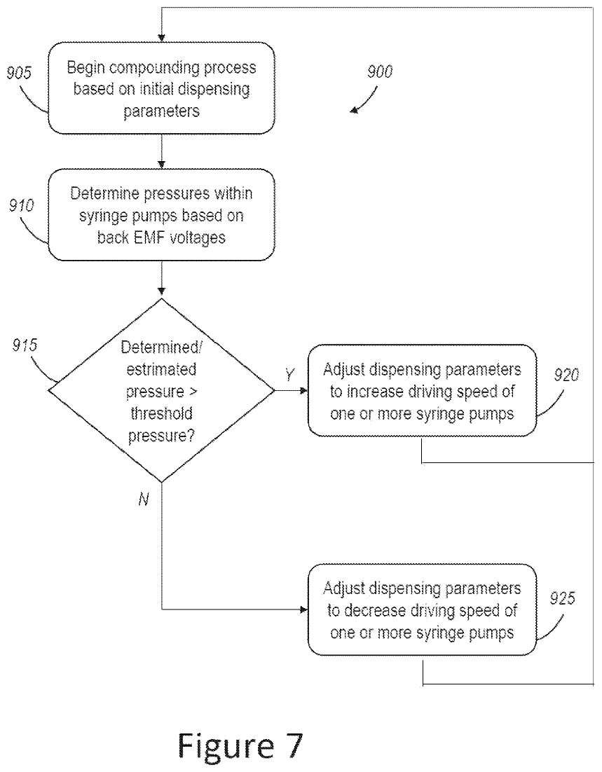

At block 810, the pressures within each of the plurality of syringe pumps are determined based upon received signals indicative of the measured back EMF voltages. As discussed with respect to FIG. 7, this determination can in some embodiments include a discrete intermediate step of determining the torque being applied by the motor and/or the force being applied to the syringe plunger. In some embodiments, the pressure can be directly determined from the measured back EMF voltage based at least in part upon the dimensions of the syringe.

At block 815, the pressure at a manifold luer connector or other bottleneck downstream of the syringe pumps may be estimated based at least in part on the determined pressures within a plurality of syringe pumps. In some embodiments, this estimate may be an average of the determined pressures within the plurality of syringe pumps currently dispensing fluid into the outlet lines. In other embodiments, the estimate may also be based at least in part on the dimensions or other characteristics of the syringe pumps and/or other components of the compounder system.

The estimated pressure can, like the determined pressure within the syringes, be compared to upper and/or lower threshold pressures in respective blocks 820 and 830, and the results of that comparison used to control or adjust the operation of one or more of the syringe pumps of the compounder. If the estimated pressure exceeds an upper threshold pressure, the process may move to a block 825 where the driving speeds of one or more syringe pumps are decreased. If the estimated pressure is below a threshold pressure, which may be different than the upper threshold pressure, the process may move to a block 835 where the driving speeds of one or more syringe pumps are increased. These adjustments can change, improve, modify, and/or optimize the dispensing routine to avoid overpressure situations while increasing where possible the dispensing rates of certain component fluids.

In an embodiment in which multiple syringe pumps are simultaneously operating, the operating parameters of the various syringe pumps may be changed, improved, modified, and/or optimized to reduce the overall compounding time for a given compounding process while avoiding overpressure events which can cause backflow and/or valve damage. In some embodiments, dispensing parameters for a given mixture may be adjusted or optimized based upon back EMF voltage measurements of a plurality of syringe pumps. The use of back EMF voltage measurements provides a method of monitoring and optimizing a compounding process that is sensorless or that lacks a sensor independent from a measurement of the EMF voltage. This monitoring and optimization can be accomplished without requiring modifications to or increases in the cost of disposable components, such as the disposable syringes of the syringe pumps.

FIG. 7 is a flow diagram illustrating an example embodiment of a method 900 of adjusting dispensing parameters for a compounding process based at least in part on measured back EMF voltages from a plurality of syringe pumps. At block 905, a compounding process begins, the compounding process including dispensation of fluids from a plurality of source containers into a single target container using a plurality of syringe pumps. The dispensing parameters for compounding process can include both a total amount of each component solution to be dispensed, as well as a rate parameter controlling the speed at which the fluid in a given channel is dispensed. For example, the rate parameter may include a gravimetric or volumetric rate at which a given component solution is to be dispensed, and may include an actuator speed such as an angular velocity of a driving stepper motor or other rotary motor, or a linear rate at which a ball nut screw or other linear actuator drives a syringe plunger. In other embodiments, the dispensing parameters may be defined, for example, through an actuator speed and actuation duration.

In some embodiments, the dispensing parameters may be calculated by a controller of the compounder based on information regarding a prescribed target compound and source fluids or solutions to be compounded. In some embodiments, information regarding the prescribed target compound and/or the source solutions may be manually input by an operator. In other embodiments, information regarding the prescribed target component and/or the source solutions may be electronically retrieved, such as from a database. The initial dispensing parameters may be adjusted by an operator prior to initiation of the compounding process.

At block 910, the pressures within the syringe pumps currently dispensing fluid into the outlet lines are determined based at least in part on measured back EMF voltages of the motors driving the syringe pumps. In some embodiments, the determined pressures within the individual active syringe pumps are also used to estimate a pressure elsewhere within the compounder system, such as at or downstream of a mixing manifold, where a luer connector or other component can serve as a bottleneck.

At block 915 the determined and/or estimated pressure measurements are compared to one or more pressure threshold values. This comparison can be done to determine, for example, whether the initial dispensing parameters run a risk of an overpressure condition which could impact the operation of the compounding process. This comparison can also be done, however, to determine whether the current dispensing parameters can be safely adjusted to optimize the compounding process, such as by reducing the time remaining in the dispensing process.

If the determined and/or estimated pressure measurements exceed a pressure threshold value, the process moves to a block 920 where one or more of the initial dispensing parameters can be adjusted to reduce or eliminate a risk of an overpressure condition. In some embodiments, the dispensing conditions may be adjusted to reduce a risk of an overpressure condition, such as by reducing the flow rate of the syringe pumps with the highest determined pressure. In other embodiments, however, the dispensing conditions may be adjusted to optimize the compounding process while reducing the estimated pressure at a bottleneck location within the system, or maintaining the estimated pressure at a bottleneck location below a desired threshold value.

In such an embodiment, a remaining amount of a given source solution to be transferred may be taken into account in adjusting the dispensing parameters. Priority may be given to maintaining a high flow rate for the channels which have the largest volumes of fluid remaining to be dispensed, or with the largest amount of time remaining for active operation of a syringe. In some embodiments, the flow rate may be maintained at a high level even if the determined pressure within the syringe pumps for those channels is higher than the syringe pumps for other channels with less volume remaining to be dispensed. A reduction in flow rate of other channels with less remaining volume to be dispensed may reduce the overall estimated pressure at a bottleneck location within the compounder output tubing. This reduction in estimated pressure can allow for the maintenance of higher flow rate of, for example, a more viscous source solution with a large amount of remaining volume to be dispensed, by reducing the flow rate of one or more less viscous source solutions with smaller amounts of remaining volume to be dispensed.

If the determined and/or estimated pressure measurements do not exceed the pressure threshold value, the process can move to a block 925 where one or more of the initial dispensing parameters can be adjusted to optimize the compounding process. The remaining amount of source solution to be transferred via each of the channels of the compounder in use may be taken into account, and the flow rate adjusted upwards in channels which have the largest volume of fluid remaining to be dispensed. The process can return to the block 910, where the pressures within the syringe pumps currently dispensing fluid into the outlet lines are determined based at least in part on measured back EMF voltages of the motors driving the syringe pumps using the updated dispensing parameters. The dispensing parameters can be iteratively updated in this manner to arrive at an optimized set of dispensing parameters while monitoring the determined and/or estimated pressure measurements to avoid overpressure conditions.

By prioritizing the dispensing of the source solutions with the largest amounts of volume remaining to be dispensed, the overall dispensing time of the compounding process can be reduced, while the determined and/or estimated pressure measurements within the syringe pumps and elsewhere within the compounder output tubing can be continually monitored during an iterative adjustment process in a manner which does not require the inclusion of dedicated pressure sensors within portions of the compounder system, such as the syringes and tubing, which may be disposable.

Using a method such as the sensorless iterative method 900, an optimized set of dispensing parameters may be determined starting from a baseline default set of dispensing parameters which does not require any knowledge of the viscosity of the particular source solutions being used in a given recipe. In other embodiments, however, the initial dispensing parameters need not be a default baseline, but may be manually or automatically adjusted based on information regarding the source solutions or based on the experience of the operator, and may be further optimized using an iterative process such as the processes described herein. If such adjusted initial dispensing parameters may lead to an overpressure event, the monitoring of the pressures within the compounder can quickly identify and correct for the risk of an overpressure event.

Although many features of the embodiments shown in the Figures are specifically called out and described, it will be understood that additional features, dimensions, proportions, relational positions of elements, etc. shown in the drawings are intended to make up a part of this disclosure even when not specifically called out or described. Although forming part of the disclosure, it will also be understood that the specific dimensions, proportions, relational positions of elements, etc. can be varied from those shown in the illustrated embodiments.

Embodiments have been described in connection with the accompanying drawings. However, it should be understood that the foregoing embodiments have been described at a level of detail to allow one of ordinary skill in the art to make and use the devices, systems, etc. described herein. A wide variety of variation is possible. Components, elements, and/or steps may be altered, added, removed, or rearranged. Additionally, processing steps may be added, removed, or reordered. While certain embodiments have been explicitly described, other embodiments will also be apparent to those of ordinary skill in the art based on this disclosure.

Some aspects of the systems and methods described herein can advantageously be implemented using, for example, computer software, hardware, firmware, or any combination of software, hardware, and firmware. Software can comprise computer executable code for performing the functions described herein. In some embodiments, computer-executable code is executed by one or more general purpose computers. However, a skilled artisan will appreciate, in light of this disclosure, that any module that can be implemented using software to be executed on a general purpose computer can also be implemented using a different combination of hardware, software, or firmware. For example, such a module can be implemented completely in hardware using a combination of integrated circuits. Alternatively or additionally, such a module can be implemented completely or partially using specialized computers designed to perform the particular functions described herein rather than by general purpose computers.

While certain embodiments have been explicitly described, other embodiments will become apparent to those of ordinary skill in the art based on this disclosure. Therefore, the scope of the invention is intended to be defined by reference to the claims as ultimately published in one or more publications or issued in one or more patents and not simply with regard to the explicitly described embodiments.

1. (canceled)

2. An electronically controlled system configured to transfer fluids from a plurality of source containers to a target container, the system comprising:
a fluid transfer station comprising:
an electric motor, the electric motor comprising control circuitry configured to measure a back electromotive force (EMF) voltage during operation of the electric motor and transmit from the electric motor an output signal indicative of the measured back EMF voltage;
a pump functionally connected to the electric motor, and
an outlet line in fluid communication with the pump, the pump actuatable via the electric motor to transfer fluid between a source container and the outlet line; and
an electronic controller configured to:
receive, from the electric motor of the fluid transfer station, the transmitted output signal indicative of the measured back EMF voltage during operation of the electric motor; and
control the operation of the electric motor based at least in part on the received output signal indicative of the measured back EMF voltage.

3. The system of claim 2, wherein the pump of the fluid transfer station comprises a peristaltic pump.

4. The system of claim 2, wherein the pump of the fluid transfer station comprises a syringe pump.

5. The system of claim 4, wherein the electronic controller is configured to determine a pressure within the syringe pump of the fluid transfer station based at least in part on the received output signal indicative of the measured back EMF voltage of the electric motor of the fluid transfer station.

6. The system of claim 5, wherein the electronic controller is configured to control the operation of the electric motor of the fluid transfer station based at least in part on the determined pressure within the syringe pump functionally connected to the electric motor.

7. The system of claim 2, wherein the system comprises a plurality of fluid transfer stations, each of the plurality of fluid transfer stations comprising:
an electric motor, the electric motor comprising control circuitry configured to measure a back EMF voltage during operation of the electric motor and transmit from the electric motor an output signal indicative of the measured back EMF voltage to the electronic controller;
a pump functionally connected to the electric motor, and
an outlet line in fluid communication with the pump, the pump actuatable via the electric motor to transfer fluid between a source container and the outlet line.

8. The system of claim 7, further comprising a mixing manifold in fluid communication with the outlet lines of each of the plurality of fluid transfer stations, the mixing manifold comprising an outlet connector configured to be placed in fluid communication with a target container.

9. The system of claim 8, wherein the electronic controller is configured to estimate a pressure at the outlet connector of the mixing manifold based at least in part on the received output signals indicative of the measured back EMF voltages of the electric motors of the plurality of fluid transfer stations.

10. The system of claim 7, wherein each of the plurality of fluid transfer stations additionally comprises:
a source check valve disposed between the pump of the fluid transfer station and a source inlet configured to be placed in fluid communication with the source container; and
a target check valve disposed between the pump of the fluid transfer station and the outlet line.

11. The system of claim 10, wherein each of the plurality of fluid transfer stations additionally comprises a connector configured to place the pump of the fluid transfer station in fluid communication with the outlet line and the source container, and wherein each of the source check valve and the target check valve are disposed within the connector.

12. A method of controlling fluid transfer from at least one source container to a target container, the method implemented by an electronic controller of a fluid transfer system, the method comprising:
receiving, from an electric motor of a fluid transfer station of the fluid transfer system, the electric motor functionally connected to a pump in fluid communication with an outlet line, an output signal indicative of a back electromotive (EMF) force measured by the electric motor during operation of the electric motor according to at least one initial driving parameter;
determining at least one updated driving parameter based at least in part on the received output signal indicative of the measured back EMF voltage to adjust a rate of fluid transfer through the fluid transfer station from the source container to the target container; and
controlling the operation of the electric motor of the fluid transfer station based at least in part on the at least one updated driving parameter.

13. The method of claim 12, wherein the pump of the fluid transfer station comprises a peristaltic pump.

14. The method of claim 12, wherein the pump of the fluid transfer station comprises a syringe pump.

15. The method of claim 14, further comprising determining, by the electronic controller, a pressure within the pump of the fluid transfer station based at least in part on the received output signal indicative of the measured back EMF voltage of the electric motor of the fluid transfer station.

16. The method of claim 15, wherein the electronic controller is configured to compare the determined pressure within the syringe pump of the fluid transfer station to a threshold pressure in order to identify an overpressure condition

17. The method of claim 15, wherein the at least one updated driving parameter is determined based at least in part on the determined pressure within the syringe pump functionally connected to the electric motor.

18. The method of claim 17, wherein determining the at least one updated driving parameter comprises reducing a driving speed of the syringe pump of the fluid transfer station.

19. The method of claim 12, wherein the system comprises a plurality of fluid transfer stations, each of the plurality of fluid transfer stations comprising:
an electric motor, the electric motor comprising control circuitry configured to measure a back EMF voltage during operation of the electric motor according to at least one initial driving parameter and transmit from the electric motor an output signal indicative of the measured back EMF voltage to the electronic controller;
a pump functionally connected to the electric motor, and
an outlet line in fluid communication with the pump, the pump actuatable via the electric motor to transfer fluid between a source container and the outlet line;
wherein the electronic controller is configured to determine at least one updated driving parameter for each of the plurality of fluid transfer stations based at least in part on the received output signal indicative of the measured back EMF voltage of the motor to adjust a rate of fluid transfer through that fluid transfer station from the source container to the target container.

20. The method of claim 19, wherein the system further comprises a mixing manifold in fluid communication with the outlet lines of each of the plurality of fluid transfer stations, the mixing manifold comprising an outlet connector configured to be placed in fluid communication with a target container.

21. The method of claim 20, further comprising:
estimating a pressure at the outlet connector of the mixing manifold based at least in part on the received output signals indicative of the measured back EMF voltages of the electric motors of the plurality of fluid transfer stations; and
determining the at least one updated driving parameter for at least one of the plurality of fluid transfer stations based at least on part on the estimated pressure at the outlet connector of the mixing manifold.
